(19) United States
(12) Patent Application Publication
(10) Pub. No.: US 2025/0217866 A1
(43) Pub. Date: Jul. 3, 2025

(54) INFORMATION PROCESSING DEVICE

(71) Applicant: TOYOTA JIDOSHA KABUSHIKI KAISHA, Toyota-shi (JP)

(72) Inventor: Naoki MIURA, Tokyo (JP)

(73) Assignee: TOYOTA JIDOSHA KABUSHIKI KAISHA, Toyota-shi (JP)

(21) Appl. No.: 18/915,376

(22) Filed: Oct. 15, 2024

(30) Foreign Application Priority Data
Dec. 28, 2023 (JP) 2023-223343

(51) Int. Cl. G06Q 30/0601; G06Q 10/087

(52) U.S. Cl. CPC G06Q 30/0631; G06Q 10/087

(57) ABSTRACT

An information processing device includes a control unit, wherein the control unit acquires information of one or more products, determines whether or not the product satisfies the first condition based on an initial specification of the vehicle owned by the user, determines whether or not the product satisfies the second condition based on a specification change history of the vehicle, determines whether or not the product satisfies the third condition based on individual information of the user, identifies each product satisfying all of the first condition, the second condition, and the third condition as a target product, and notifies the user of the information of the identified target product.

### CROSS-REFERENCE TO RELATED APPLICATION

This application claims priority to Japanese Patent Application No. 2023-223343 filed on Dec. 28, 2023, incorporated herein by reference in its entirety.

### BACKGROUND

### 1. Technical Field

The present disclosure relates to information processing devices.

### 2. Description of Related Art

A technique of notifying a user of information on a vehicle product is conventionally known in the art. For example, Japanese Patent No. 7082595 (JP 7082595 B) discloses a vehicle manufacturing support system that, when it receives a specified vehicle body and specified charging performance of a used battery from a user, provides information indicating a combination of a vehicle body and a used battery that matches the specified vehicle body and the specified charging performance.

### SUMMARY

For example, installable vehicle models are typically determined in advance for vehicle products, and a user purchases a product compatible with the model of the vehicle that he/she owns. However, even the product compatible with the model of the vehicle may not be able to be installed in the vehicle due to, for example, interference of the product with another product that the user installed in the vehicle in the past. If the specifications of the vehicle have thus been changed from its initial specifications, the user may get frustrated because the product he/she purchased cannot actually be installed in the vehicle even though it is compatible with the model of the vehicle. It is a common practice to notify a user of information on a vehicle product in order to promote sales of the vehicle product. However, if, for example, a user is notified of information on a vehicle product that he/she viewed or purchased in the past, he/she may feel annoyed and is more likely to ignore the notification. Therefore, there is room for improvement in technique of notifying a user of information on a vehicle product.

The present disclosure was made in view of the above circumstances, and an object of the present disclosure is to improve a technique of notifying a user of information on a vehicle product.

An information processing device according to an embodiment of the present disclosure is
an information processing device including a control unit.

The control unit is configured to
acquire information on one or more products,
determine whether the product satisfies a first condition, based on an initial specification of a vehicle owned by a user,
determine whether the product satisfies a second condition, based on a specification change history of the vehicle,
determine whether the product satisfies a third condition, based on individual information on the user,
identify each of the products that satisfy all of the first condition, the second condition, and the third condition as a target product, and
notify the user of information on the identified target product.

The embodiment of the present disclosure improves the technique of notifying a user of information on a vehicle product.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a system according to an embodiment of the present disclosure;

FIG. 2 is a block diagram illustrating a schematic configuration of a terminal device;

FIG. 3 is a block diagram illustrating a schematic configuration of an information processing device;

FIG. 4 is a schematic diagram illustrating an example of user information stored in the information processing device;

FIG. 5 is a schematic diagram illustrating an exemplary vehicle-information of FIG. 4; and

FIG. 6 is a flowchart illustrating an operation of the information processing device.

### DETAILED DESCRIPTION OF EMBODIMENTS

Hereinafter, an embodiment of the present disclosure will be described.

### Outline of Embodiment

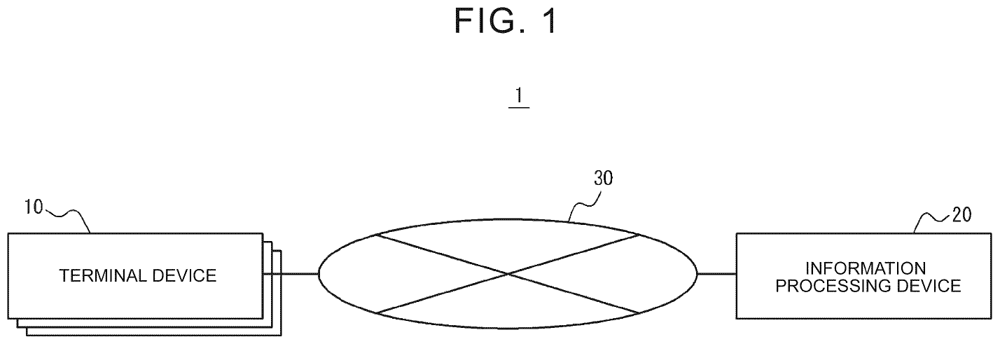

The outline of a system 1 according to an embodiment of the present disclosure will be described with reference to FIG. 1. The system 1 includes one or more terminal devices 10 and an information processing device 20. Each of the terminal devices 10 and the information processing device 20 can communicate with each other via a network 30 such as the Internet.

The terminal device 10 is, for example, a computer such as a Personal Computer (PC, a mobile telephone, a smart phone, or a tablet terminal. In the present embodiment, the terminal device 10 is used by, for example, a user who owns a vehicle. The information processing device 20 includes one computer or a plurality of computers that can communicate with each other.

In the present embodiment, the information processing device 20 provides a EC website in which a user can purchase a vehicular product (hereinafter, also simply referred to as a “product”). The user creates a user account in advance using the terminal device 10 and logs in to EC website through predetermined user authorization. After logging in, the user can view product information or purchase a product by electronic payment.

First, the outline of the present embodiment will be described, and the details will be described later. The information processing device 20 according to the present embodiment acquires information of one or more products. The information processing device 20 determines whether the product satisfies the first condition based on the initial specification of the vehicle owned by the user. The information processing device 20 determines whether the product satisfies the second condition based on the specification change history of the vehicle. The information processing device 20 determines whether the product satisfies the third condition based on the individual information of the user. The information processing device 20 identifies each product satisfying all of the first condition, the second condition, and the third condition as the target product. Then, the information processing device 20 notifies the user of the information of the identified target product.

As described above, according to the present embodiment, a product determined to satisfy the first to third conditions based on the initial specification and the specification change history of the vehicle owned by the user and the individual information of the user is identified as the target product. By appropriately setting the first to third conditions, for example, a product that is installable in both the vehicle in the initial specification and the vehicle after the specification change and that the user has not viewed the product information on EC website is identified as the target product, and the information of the target product is notified to the user. According to such a configuration, for example, a technique of notifying a user of information of a product for a vehicle is improved in that a probability that information of a product that is not installable in the vehicle or a product that has been viewed by the user is notified to the user is reduced.

Next, each configuration of the system 1 will be described in detail.

### Configuration of Vehicle

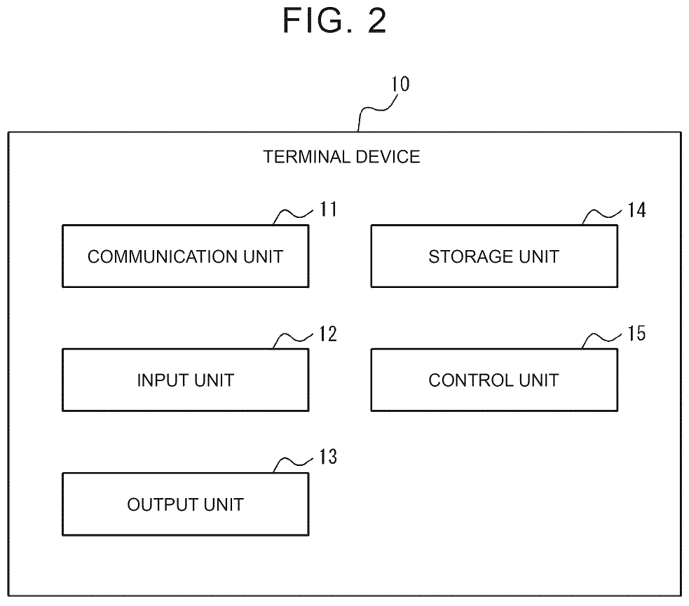

Each component included in the terminal device 10 will be described with reference to FIG. 2. The terminal device 10 includes a communication unit 11, an input unit 12, an output unit 13, a storage unit 14, and a control unit 15.

The communication unit 11 includes one or more communication interfaces connected to the network 30. The communication interfaces correspond to, for example, a mobile communication standard such as 4th Generation (4G) or 5th Generation (5G), a wired Local Area Network (LAN) standard, or a wireless LAN standard, but are not limited thereto, and may correspond to any communication standard.

The input unit 12 includes one or more input devices that detect an input operation by a user. The input device is, for example, a physical key, a capacitive key, a mouse, a touch panel, a touch screen integrally provided with a display, a camera, a microphone, or the like, but is not limited thereto. Alternatively, the input unit 12 may include an interface for connecting an external input device.

The output unit 13 includes one or more output devices for outputting information. For example, the output devices are, but are not limited to, a display that outputs information as images, a speaker that outputs information as audio, and the like. Alternatively, the output unit 13 may include an interface for connecting an external output device.

The storage unit 14 includes one or more memories. The memories are, for example, a semiconductor memory, a magnetic memory, or an optical memory, but are not limited to these memories. Each memory included in the storage unit 14 may function as, for example, a main storage device, an auxiliary storage device, or a cache memory. The storage unit 14 stores any information used for the operation of the terminal device 10. For example, the storage unit 14 may store, a system program, an application program, or the like.

The control unit 15 includes one or more processors, one or more programmable circuits, one or more dedicated circuits, or a combination of these. The processor may be, but is not limited to, a general-purpose processor such as, for example, Central Processing Unit (CPU) or Graphics Processing Unit (GPU), or a special-purpose processor specialized for a specific process. The programmable circuitry is, for example, but not limited to, Field-Programmable Gate Array (FPGA). The dedicated circuitry is, for example, but not limited to, Application Specific Integrated Circuit (ASIC). The control unit 15 controls the operation of the terminal device 10 as a whole.

### Configuration of Information Processing Device

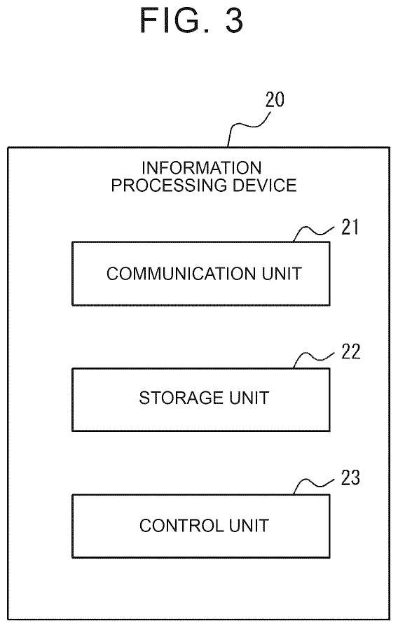

As shown in FIG. 3, the information processing device 20 includes a communication unit 21, a storage unit 22, and a control unit 23.

The communication unit 21 includes one or more communication interfaces connected to the network 30. The communication interfaces correspond to, for example, a wired LAN or a wireless LAN standard, but are not limited thereto, and may correspond to any communication standard.

The storage unit 22 includes one or more memories. Each memory included in the storage unit 22 may function as, for example, a main storage device, an auxiliary storage device, or a cache memory. The storage unit 22 stores any information used for the operation of the information processing device 20. For example, the storage unit 22 may store a system program, an application program, embedded software, a database, and the like.

In the present embodiment, the storage unit 22 stores a product database. The information stored in the product database may be input, for example, by an operator. The product data base stores, for each product that is sold at the EC website, the conditions (hereinafter, also referred to as installation conditions) of vehicles in which the product is installable. Specifically, the installation condition may include a condition that limits, for example, a vehicle type, a grade, or a year. Installation conditions may also include conditions such as that certain other products are or are not installed in the vehicle, or that the vehicle has or has not been subjected to certain processing.

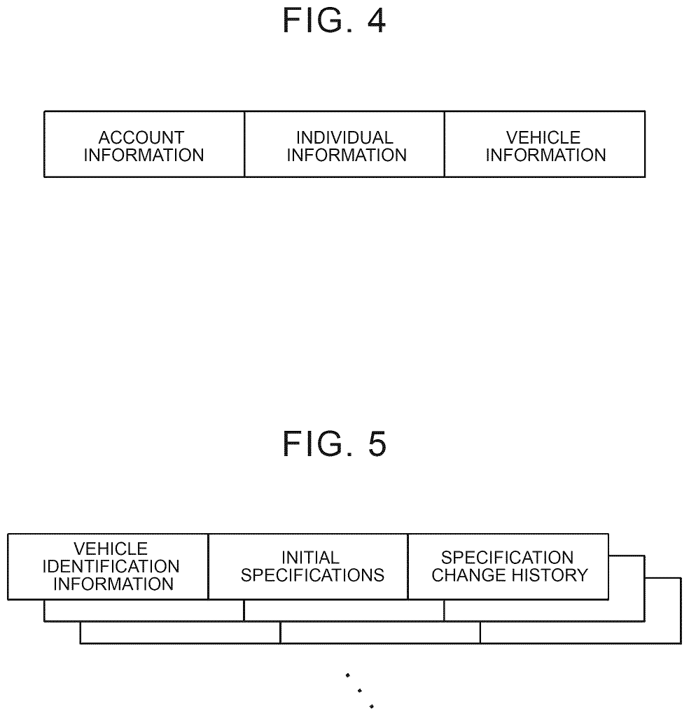

In addition, the storage unit 22 stores user data for the respective users who have already acquired the user accounts of EC website. As shown in FIG. 4, the user information may include account information, individual information, and vehicle information. The individual information and the vehicle information are stored in association with the account information.

The “account information” includes, for example, but not limited to, a ID and a password of a user, and may include any information related to a user account. For example, the account information may further include a mail address, an address, and electronic payment information of the user.

The “individual information” includes, for example, but is not limited to, an event log of a user account, and may include any information specific to a user who uses a EC website. The event log is, for example, time-series recording of various events that have occurred with respect to a user account of a user who uses EC website. Examples of the event include, but are not limited to, vehicle registration, viewing of product information, and purchase of a product. In the present embodiment, for example, a vehicle registration date, a date, and time each product information was viewed, a product purchase history, and the like can be identified from the event log.

“Vehicle information” includes any information about a vehicle owned by a user. As illustrated in FIG. 5, in the present embodiment, the vehicle information includes vehicle identification information, initial specifications, and a specification change history.

The “vehicle identification information” is information for uniquely identifying the vehicle.

The “initial specification” is information indicating the specification of the vehicle at the time of manufacture or sale. In the present embodiment, the “initial specification” indicates, for example, a vehicle type, a grade, an age, an installed product, and the like, but is not limited thereto, and may indicate an arbitrary specification of the vehicle. Note that the vehicle identification information and the initial specification may be stored when the user performs vehicle registration. For example, after the user logs in to EC site using the terminal device 10, the user registers the vehicle by inputting the information of the vehicle owned by the user to the terminal device 10.

The “specification change history” is information in which the history of specification change after sales of the vehicle is recorded in time series. In the present embodiment, the “specification change” is, for example, a product installed after the sale of the vehicle, a removed product, a process applied to the vehicle, or the like, but is not limited thereto. From the specification change history, the current specification of the vehicle of the user can be identified. The specification change history may be stored when the user or the dealer changes the specification of the vehicle. For example, after the user logs in to EC site using the terminal device 10, the specification change history may be accumulated by inputting, to the terminal device 10, the content of the specification change made to the vehicle owned by the user. Alternatively, the dealer may store the specification change history by inputting the contents of the specification change made to the vehicle of the user to the dedicated terminal.

When the user owns a plurality of vehicles, vehicle registration may be performed for each vehicle. In this case, the vehicle information includes the vehicle identification information, the initial specification, and the specification change history described above for each registered vehicle.

The control unit 23 includes one or more processors, one or more programmable circuits, one or more dedicated circuits, or a combination of these. The control unit 23 controls the operation of the information processing device 20 as a whole.

### Operation of the Information Processing Device

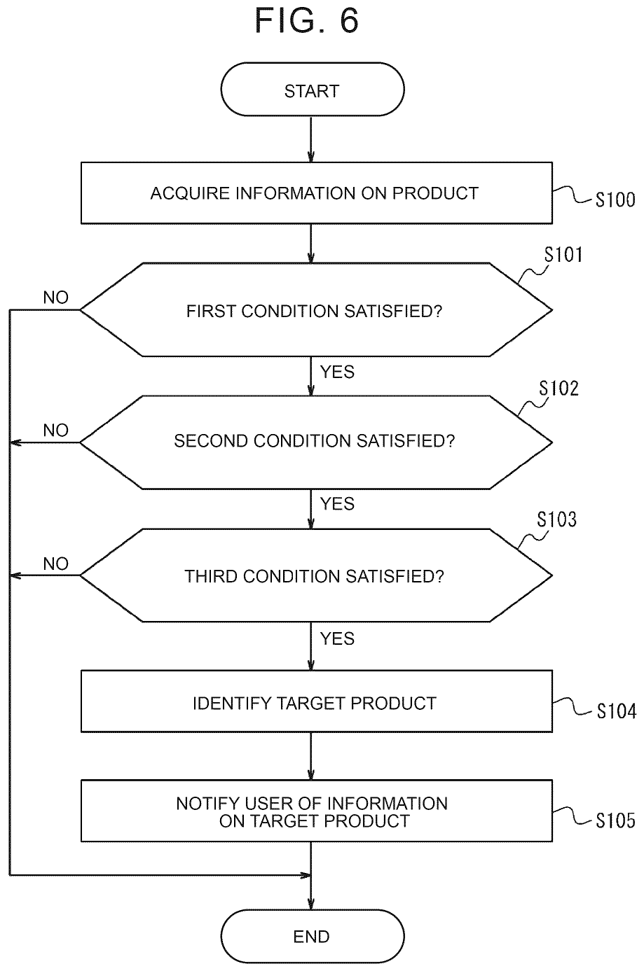

The operation of the information processing device 20 will be described with reference to FIG. 6.

S100: The control unit 23 of the information processing device 20 acquires information on one or more products.

Specifically, the control unit 23 acquires information on one or more products from the product database stored in the storage unit 22. The control unit 23 may acquire information on one or more products when the information on the one or more products is newly registered in the product database or the information on the one or more products registered in the product database is changed. Alternatively, the control unit 23 may acquire information on one or more products selected by the operator from among a plurality of products registered in the product database. The acquired product information includes the above installation conditions (that is, the conditions of the vehicle in which the product is installable).

When information of a plurality of products is acquired by S100, a process of S103 is performed on each of the plurality of products from S101 to be described later.

S101: The control unit 23 determines whether or not the vehicle satisfies the first condition based on the initial specification of the vehicle owned by the user. If it is determined that the item satisfies the first criterion (S101—Yes), the processing proceeds to S102. On the other hand, if it is determined that the device does not satisfy the first criterion (S101—No), the processing is terminated.

The “first condition” is a condition that the product is installable in the vehicle with the initial specification. Specifically, the control unit 23 refers to an initial specification (for example, a vehicle type, a grade, an annual formula, or the like) included in the vehicle information stored in the storage unit 22, and determines that the product satisfies the first condition when the vehicle in the initial specification satisfies the installation condition of the product.

S102: The control unit 23 determines whether or not the vehicle satisfies the second condition based on the specification change history of the vehicle. If it is determined that the item satisfies the second condition (S102—Yes), the processing proceeds to S103. On the other hand, if it is determined that the item does not satisfy the second condition (S102—No), the processing is terminated.

The “second condition” is a condition that the product is installable in the vehicle with the current specification identified from the specification change history. Specifically, the control unit 23 refers to a specification change history (for example, a product installed after the sale of the vehicle, a removed product, a processing applied to the vehicle, and the like) included in the vehicle information stored in the storage unit 22, and identifies a current specification of the vehicle. When the vehicle in the current specification satisfies the installation condition of the product, the control unit 23 determines that the product satisfies the second condition.

S103: The control unit 23 determines whether or not the item satisfies the third criterion based on the individual information of the user. If it is determined that the item satisfies the third criterion (S103—Yes), the processing proceeds to S104. On the other hand, if it is determined that the item does not satisfy the third criterion (S103—No), the processing ends.

The “third condition” may be, for example, a condition that the product information corresponds to a product added or changed after the vehicle registration date in the product database. In this case, the control unit 23 identifies the vehicle registration date from the individual information (event log) of the user, and determines that the product satisfies the third condition when the product information is added or changed after the vehicle registration date in the product database.

The “third condition” may be, for example, a condition that the product-information is not viewed by the user on EC website. In this case, the control unit 23 specifies from the individual information (event log) of the user whether the product information has been viewed, and determines that the product satisfies the third condition when the product information has not been viewed.

S104: The control unit 23 identifies each product that satisfies all of the first condition, the second condition, and the third condition as a target product.

S105: The control unit 23 notifies the user of information on the identified target product. After that, the process ends.

Specifically, the control unit 23 notifies the user of the information on the identified target product by transmitting the information to the terminal device 10 of the user. The information of the target product to be notified may include, for example, product information of the target product, and may include a URL of a web page in which product information of the target product is described in EC website. Note that the notification of the information may be performed, for example, by sending an e-mail, or may be performed by a push notification via a dedicated application installed in the terminal device 10.

When a plurality of target products is identified in S104, the control unit 23 may aggregate the information of the plurality of target products and notify the user of the information. In other words, the control unit 23 may transmit a single notification including information on a plurality of target products to the terminal device 10 of the user. According to this configuration, since the number of notifications is reduced as compared with the embodiment in which a plurality of notifications corresponding to a plurality of target products are transmitted to the terminal device 10, for example, the probability that the user feels troublesomeness is reduced.

In addition, in a case where the user owns a plurality of vehicles and vehicle registration is performed for each vehicle, the control unit 23 may identify target products for each vehicle, aggregate information of all target products identified for the plurality of vehicles, and notify the user of the information. According to this configuration, since the number of notifications is reduced as compared with the embodiment in which a plurality of notifications corresponding to each of a plurality of vehicles is transmitted to the terminal device 10, for example, the probability that the user feels troublesomeness is reduced.

As described above, the information processing device 20 according to the present embodiment acquires information on one or more products. The information processing device 20 determines whether the product satisfies the first condition based on the initial specification of the vehicle owned by the user. The information processing device 20 determines whether the product satisfies the second condition based on the specification change history of the vehicle. The information processing device 20 determines whether the product satisfies the third condition based on the individual information of the user. The information processing device 20 identifies each product satisfying all of the first condition, the second condition, and the third condition as the target product. Then, the information processing device 20 notifies the user of the information of the identified target product.

According to this configuration, a product determined to satisfy the first to third conditions based on the initial specification and the specification change history of the vehicle owned by the user and the individual information of the user is identified as the target product. By appropriately setting the first to third conditions, for example, a product that is installable in both the vehicle in the initial specification and the vehicle after the specification change and that the user has not viewed the product information on EC website is identified as the target product, and the information of the target product is notified to the user. According to such a configuration, for example, a technique of notifying a user of information of a product for a vehicle is improved in that a probability that information of a product that is not installable in the vehicle or a product that has been viewed by the user is notified to the user is reduced.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

For example, in the above-described embodiment, the configuration and operation of the information processing device 20 may be distributed among a plurality of computers capable of communicating with each other.

Further, for example, the order of S103 may be changed from the above-described S101. For example, in the above-described embodiment, for example, the determination of the second condition (and the third condition) is not performed for a product that does not satisfy the first condition, but it is also possible to perform the determination for all of the first condition, the second condition, and the third condition.

Further, in the above embodiment, the control unit 23 of the information processing device 20 may determine when to notify the user of the information on the target product, based on the product purchase history of the user identified from the individual information (event log) of the user. Specifically, the control unit 23 identifies a time period (for example, from 19:00 to 20:00, for example) in which the frequency of purchase of the product by the user is highest, based on the product purchase history of the user. Then, the control unit 23 notifies the user of the information of the target product in the identified time period. According to this configuration, the probability of the user purchasing the target product can be improved.

Further, in the above embodiment, the control unit 23 may notify the information of the target product up to a predetermined upper limit number of times (for example, once) every predetermined period (for example, every day). According to this configuration, since the number of notifications is reduced as compared with the embodiment in which a plurality of notifications is transmitted to the terminal device 10 within a predetermined period, the probability that the user feels troublesomeness is reduced.

Further, in the above embodiment, the control unit 23 may acquire status information indicating the production status or inventory status of the target product, the availability status of an installer (e.g., a dealer) of the target product, or both, and determine when to notify the user of the information of the target product, based on the status information. Specifically, the control unit 23 may inquire, for example, a manufacturer or a dealer of the target product of the production status or the inventory status of the target product. In addition, the control unit 23 may inquire of the installer of the target product about the availability status of the installer. The control unit 23 notifies the user of the information of the target product when the production of the target product is not stagnant or the inventory of the target product remains and/or the installer is available. According to this configuration, it is possible to reduce the probability that the time from the time when the user who has received the notification purchases the target product (for example, purchases the target product by electronic payment on EC website) to the time when the target product is actually installed in the vehicle becomes unnecessarily long.

An embodiment is also possible in which, for example, a general-purpose computer functions as the information processing device 20 according to the above embodiment. Specifically, a program describing processing contents implementing each function of the information processing device 20 according to the above embodiment is stored in a memory of the general-purpose computer, and the program is read out and executed by the processor. Therefore, the present disclosure can also be realized as a program that can be executed by the processor or a non-transitory computer-readable medium that stores the program.

What is claimed is:

1. An information processing device comprising a control unit, wherein the control unit is configured to
acquire information on one or more products,
determine whether the product satisfies a first condition, based on an initial specification of a vehicle owned by a user,
determine whether the product satisfies a second condition, based on a specification change history of the vehicle,
determine whether the product satisfies a third condition, based on individual information on the user,
identify each of the products that satisfy all of the first condition, the second condition, and the third condition as a target product, and
notify the user of information on the identified target product.

2. The information processing device according to claim 1, wherein
the first condition is a condition that the product is installable in the vehicle with the initial specification,
the second condition is a condition that the product is installable in the vehicle with a latest specification identified from the specification change history, and
the third condition is a condition that product information on the product has not been viewed by the user.

3. The information processing device according to claim 1, wherein the control unit is configured to, when the user owns a plurality of vehicles, identify the target product for each of the vehicles, aggregate information on all of the target products identified for the vehicles, and notify the user of the aggregated information.

4. The information processing device according to claim 1, wherein the control unit is configured to determine when to notify the user of the information on the target product, based on a product purchase history of the user identified from the individual information.

5. The information processing device according to claim 1, wherein the control unit is configured to
further acquire status information indicating a production status or inventory status of the target product, an availability status of an installer of the target product, or both the production status or inventory status and the availability status, and
determine when to notify the user of the information on the target product, based on the status information.
